(19) United States
(12) Patent Application Publication
(10) Pub. No.: US 2007/0041883 A1
(43) Pub. Date: Feb. 22, 2007

(54) Process for hydrometallurgical treatment of electric arc furnace dust

(76) Inventors: Brendan McDevitt, Brisbane, CA (US); Richard Karkkainen, Boerne, TX (US); Eduardo Sacris, Quezon City (PH); David Nahmad, Anaheim, CA (US); Elizabeth Sendil, Pacifica, CA (US)

Correspondence Address: PILLSBURY WINTHROP SHAW PITTMAN LLP, P.O. BOX 10500, MCLEAN, VA, 22102, US

(21) Appl. No.: 11/349,054

(22) Filed: Feb. 6, 2006

Related U.S. Application Data
(60) Provisional application No. 60/650,014, filed on Feb. 4, 2005.

(51) Int. Cl. C01G 55/00

(52) U.S. Cl. 423/22

(57) ABSTRACT

A process for treating electric arc furnace dust to recover lead, zinc, iron and precious metals by washing the dust, solubilizing and electrowinning some metals, and extracting other metals from the solids left after the solubilizing step.

### RELATED APPLICATIONS

This application claims priority from U.S. Provisional Patent Application Ser. No. 60/650,014 filed Feb. 4, 2005.

### FIELD OF THE INVENTION

This present invention relates generally to a method for removing lead, zinc, and precious metals from Electric Arc Furnace (EAF) dust and for recycling EAF dust.

### BACKGROUND OF THE INVENTION

During the steel making process, approximately two percent of the raw materials added to the furnace are converted into bag house dust. It has been estimated that 0.5 to 0.6 million tons of electric arc furnace dust (EAFD) containing zinc and lead are generated annually in the United States.

EAF dust is a complex material consisting mostly of metal oxides. Since electric arc furnaces typically rely on scrap metal for their charge and the composition of the dust is directly associated with the chemistry of the metallic charge used, increased use of galvanized steel to manufacture automobile bodies and paneling has increased the zinc content in the dust over the years. When galvanized steel scrap is melted in a steel making furnace, most of the zinc vaporizes and ends up in the dust as zinc oxide and zinc ferrite. In addition, trace quantities of precious metals such as gold are also found in EAFD.

Most of the metals present in the dust, such as iron, are present in several valence states, which additionally complicates the development of suitable processes for the treatment of EAF dust. For example, iron is present as metallic iron, Fe(+2), and Fe(+3). Zinc and lead are also present in both metallic form and as metal oxides of varying oxidation states. The chemical complexity of the dust is enhanced by the amphoteric nature of these metals, the reducing or oxidizing conditions in the furnace and the presence of large quantities of metal oxides such as calcium oxide and magnesium oxide. These alkaline earth metal oxides also make the EAF dust suspensions highly alkaline.

EAF dust cannot be simply disposed of. EAF dust fails environmental tests due to the presence of one or more of metals such as lead, cadmium, chromium and occasionally selenium at levels in excess of the regulatory limit. Thus, increasing disposal costs for this listed waste and more restrictive environmental legislation have led to the search for economically viable ways to recycle dust back into the process.

Dust from EAF is rich in iron oxide, lead, zinc and other metals. Although attempts have been made to reclaim the iron oxide from the dust, dust containing lead and zinc cannot be readily recycled into the steel making processes. Thus, a need exists for extracting the lead and zinc from the EAF dust in order recycle the iron back into the process. In addition, the zinc and precious metals extracted from the process can be then sold commercially.

There are four common processes to treat EAF dust. Stabilization/fixation processes are used to encapsulate toxic metals such as lead and cadmium such that the dust will not be judged as hazardous in TCLP tests. The stabilized/fixed waste is disposed in commercial non-Title C landfills after being delisted. This process is widely practiced. However, with this method, there is no metal recovery.

Acid based extraction processes can be used to treat EAF dust to dissolve metals of interest. Since the inherent pH of a dust suspension is greater than 11, excessive amounts of acid would be required in this process. Thus, acid based extractions of EAF dust are not readily commercialized.

Pyrometallurgical processes are also commonly used to remove lead and zinc from EAF dust by fuming and then condensing the metals in relatively pure form. This technology is practiced in the United States and Mexico. The residual waste solid is delisted and available for use in roadbeds and can be disposed in a landfill. However, with hydrometallurgical processes, there is no recycle of iron to the EAF process. In addition, small particles of the lead or lead oxide in the vapor stream can be difficult to remove entirely. Thus, one concern with this process is the contamination of neighboring areas due to lead fall out.

Finally, caustic based processes in which the leaching and dissolving steps employ simple chemistry that takes advantage of the amphoteric nature of zinc, lead, tin, arsenic, selenium and aluminum and the basic conditions provided by the calcium oxide present in the EAF dust can be used to treat EAF dust.

### SUMMARY OF THE INVENTION

Thus, the object of the present invention is to provide a method to remove lead, zinc, and precious metals from steel making dust, recycle the iron back into the process and obtain raw metallic zinc and precious metals of high purity through a caustic based hydrometallurgical process.

The following chemical reactions, in part, represent the dissolution of lead and zinc under the proposed process conditions. Lead monoxide (PbO) dissolves readily in alkalis forming the plumbites (Na₂PbO₂). Lead dioxide (PbO₂) is practically insoluble in water or alkaline solutions, but it can react with alkalis to form plumbates (Na₂PbO₃). Lead sesquioxide (Pb₂O₃) and lead tetroxide (Pb₃O₄), both insoluble in water decompose to PbO₂ and PbO in hot water, which are rendered soluble as described above.
PbO+2NaOH→Na₂PbO₂+H₂O
PbO₂+2NaOH→Na₂PbO₃+H₂O
Zn+4NaOH→Na₂Zn(OH)₃.H₂O+2Na⁺+2e−
Zn+3NaOH+H₂O→NaZn(OH)₃.H₂O+Na⁺+e−
Zn+2NaOH→ZnO+H₂O+2Na⁺+2e−
Zn+2NaOH+H₂O→Na₂Zn(OH)₄
There are six main steps to the process: water wash, extraction, cementation or displacement, electrowinning, gold recovery, and thermal treatment of recycled iron stream.

The first step is to water wash the EAF dust. There are halide salts in EAF dust that will be dissolved by the extraction liquor used in subsequent steps if not removed prior to the extraction. The salts do not interfere with the extraction of any of the metals of interest; however, the salts will interfere with the ability to electrowin pure (99%) zinc from that liquor. Therefore, to avoid this interference, it is important to water wash the EAF dust and then separate the solid from the slurry in a filter press. The salt may be removed from the water in an evaporator and the water recycled. The source of the halide salts is the flux in the EAF melt; therefore, they can be reused in service.

In the extraction step, an extraction with approximately 25% caustic penetrates the solids structure and releases metals present in complex forms in the solid structure. The chemistry is that noted above. Optimum conditions are a temperature of approximately 250 degrees Fahrenheit and a residence time of approximately three hours. Enough extraction liquor is added to maintain an approximately 15% solids slurry. Extraction of lead, cadmium and zinc occurs during this step. After the extraction, the solids are separated from the extracting liquor. Metals will be recovered from the liquor as described below.

In the cementation or displacement step, cementation of lead and other metals from the leachate is accomplished by adding finely divided zinc metal. Zinc can be used to electrochemically precipitate (cement) lead, copper and cadmium from solution. The cement cake is separated from the zinc rich liquor. The zinc rich liquor is processed by electrowinning to recover zinc as described below. The cementation of metals proceeds according to the following reactions:
Zn+Na₂PbO₂→Na₂ZnO₂+Pb
Zn+Na₂CuO₂→Na₂ZnO₂+Cu
Approximately two times the stoichiometric amount of zinc will be required to drive the reaction.

The recovered lead is not sufficiently pure for resale; the main contaminant is zinc. The method of purification is to use the material as make up to the lead/zinc condenser system used in the reduction step of the iron recycle stream. The lead/zinc condenser system is a molten metal system consisting of a scrubber, decanter and pumps. The significant specific gravity differential between molten lead ad zinc allows for clean separation.

The next step involves electrowinning. Electrowinning is an electrochemical method to recover elemental metal for reuse by processing moderate to high concentration aqueous solutions. Electrowinning uses direct current electricity applied to electrodes immersed in an aqueous solution to convert dissolved metal ions to elemental metal. Positively charged metal ions migrate to the negative electrode, where the metal ions are reduced to elemental metal. Electrowinning applies principles and equipment similar to those of commercial electroplating but differs in its goal to recover metals rather than form a decorative or protective coating. In electrowinning, the metal appearance is unimportant, so thicker coats can be allowed to accumulate. Metals with high electrode potential are easily reduced and deposited on the cathode. Gold and silver are ideal candidates, but cadmium, chromium, copper, lead, nickel, tin and zinc can be recovered using a higher voltage.

The main reactions during electrolysis are as follows:

Cathode: Na₂ZnO₂+2H₂O+2e−→Zn+2NaOH+2 OH⁻
Anode: 2OH—→H₂O+1/2O₂+2 e−
Total: Na₂ZnO₂+H₂O→Zn+2NaOH+1/2O₂

In the electrowinning step, powder is produced with 99.95% purity by electrowinning from the lead depleted solution. Stainless steel electrodes are used as both anode and cathode. The caustic solution strength was approximately 20%, voltage was approximately 2.4 to 2.7 volts, current density was approximately 700 to 1100 A/square meter, and electric consumption was approximately 2.5 to 2.6 kwh/kg zinc.

The zinc powder produced will immediately react with caustic to form zinc oxide, if additional chemicals to inhibit that possibility are not used. The classical zinc plating technique requires sodium cyanide to be added to the plating bath. Other less toxic formulations have also proven to be successful. One such formulation is the use of gelatin in concentrations as low as approximately 0.1 ppm.

The next step is to extract precious metals such as gold which remain in the iron recycle stream. As an example, this section will discuss the extraction of gold. Even if cyanide, a common complexing and extraction agent for gold, is present in the caustic recycle stream it does not extract the gold. The presence of abundant sodium hydroxide inhibits extraction of gold. In the gold extraction step, gold is extracted from the iron recycle stream by utilizing a separate cyanide extraction step on the iron recycle stream. The sodium cyanide is used in a separate extraction loop without an excess of sodium hydroxide being present. The gold is recovered by adding finely divided zinc. The zinc displaces the gold and the gold drops out as the insoluble metal. The gold is recovered by filtration. The zinc is then recovered by electrowinning.

In the thermal treatment of recycle iron stream step, the residue iron stream is reduced in a rotary kiln to convert most of the iron oxides to iron. With the temperature of the kiln at approximately 1800 degrees Fahrenheit, the zinc that was not converted to zincates and solubilized in caustic fumes off. At approximately 1800 degrees Fahrenheit the zinc ferrite bond is broken. The zinc is fumed off and the iron oxide becomes available to be reduced. The fumed stream is collected and separated in the lead/zinc splash condenser. An alternative collection technology is the use of a water cooled plate upon which zinc may condense. Zinc is then mechanically removed from the plate. The reduced iron stream is recycled back to the EAF.

### BRIEF DESCRIPTION OF THE DRAWINGS

FIGS. 1A-1C are diagrams illustrating the entire process for the removal of lead, zinc, and precious metals from steel making dust, recycling the iron back into the process and obtaining raw metallic zinc and precious metals of high purity through a caustic based hydrometallurgical process.

### DETAILED DESCRIPTION OF PREFERRED EMBODIMENTS

Embodiments of the present invention will now be described in detail with reference to the drawings, which are provided as illustrative examples so as to enable those skilled in the art to practice the invention. Notably, the figures and examples below are not meant to limit the scope of the present invention. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

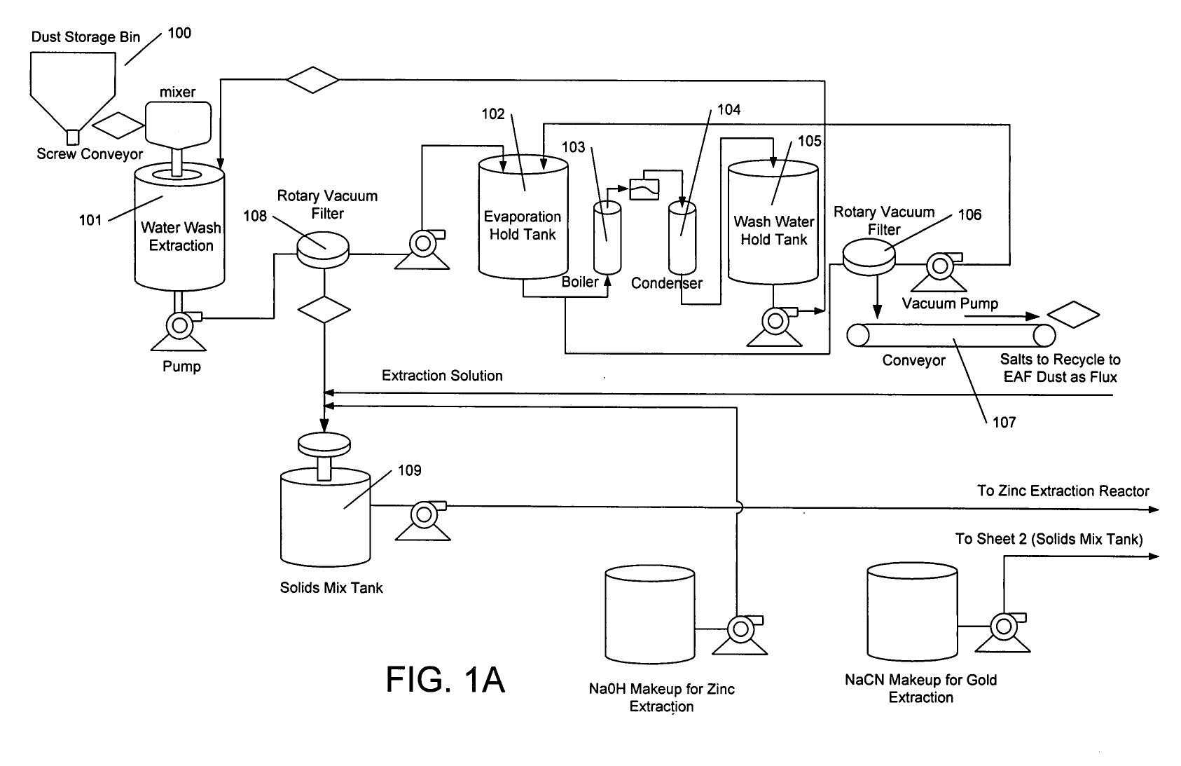

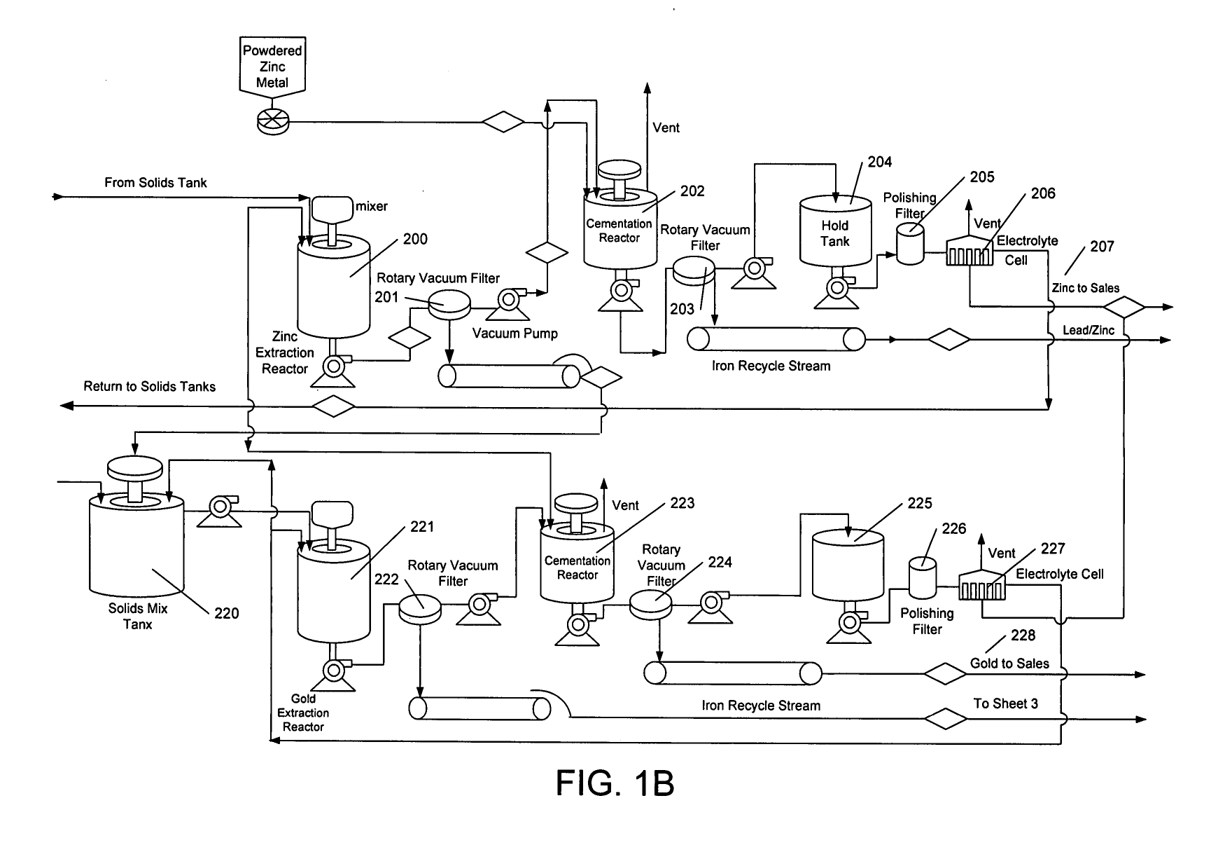

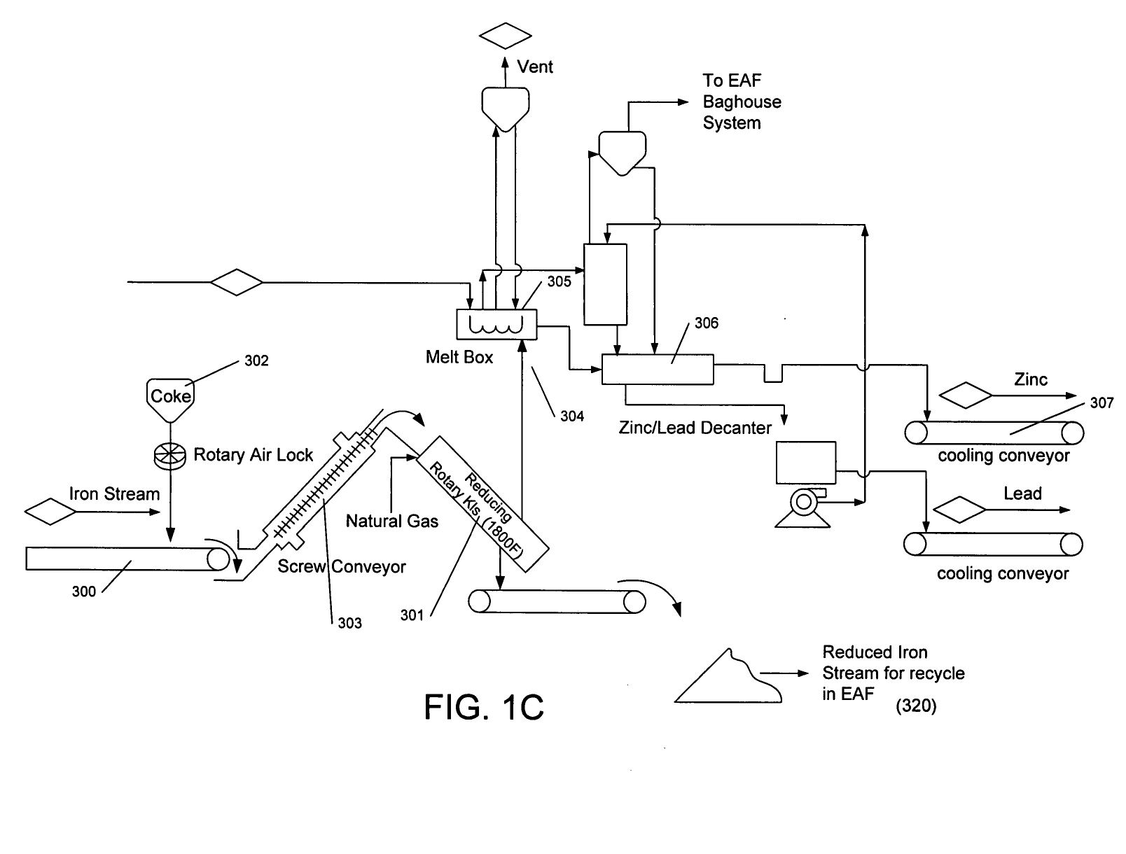

FIGS. 1A-1C illustrate the entire process of a certain embodiment of the invention. FIG. 1A show the beginning steps of the process, specifically the water wash and the recovery of water and salts steps.

In the water wash step, the EAF dust is stored in a carbon steel bin [100]. The bin contains sufficient volume to supply EAF dust for the process for one day. EAF dust in sufficient amount for one batch is moved by screw conveyor to a stirred vessel containing water [101] in an amount by weight equal to the weight of the conveyed EAF dust. The contents of the vessel are heated to a temperature between 80 and 120 degrees Fahrenheit. The contents of the vessel are stirred from 0.1 to 1.0 hours and then the entire contents are pumped through a filter [108] to separate the water from the solids. The filter can be a rotary vacuum filter, filter press, or any commercially available apparatus designed to separate solids from liquids.

In the recovery of water and salts step, the water flowing from the filter flows to a hold tank [102]. The water contains dissolved halide salts used as flux in the charge to the EAF. The salts can be recycled to the EAF and the water re-used in the water wash. Conventional separation methods such as distillation-condensation or reverse osmosis are technologies that can be used to effect the separation of the salts. In this embodiment of the invention, the solution of flux salts and water is heated to boiling in a heat exchanger [103]. Steam is separated and condensed to water in another heat exchanger [104]. The condensed water can be reused for wash water [105]. The solution of flux salts increases in salt concentration and precipitates the salts at which time they can be separated from the water in a filter [106]. In certain embodiments, a filter press or rotary vacuum filter can be used for this purpose. The solids from the filter are flux salts which may be accumulated and conveyed back for use in the EAF without further drying [107].

The solids from the filter [108] are discharged into a solids mix tank [109] that serves as a feed vessel to pump slurry of EAF dust, water and caustic to the zinc extraction reactor.

FIG. 1B describes the next steps of the process, the extraction step, the cementation or displacement step, the electrowinning step, and the gold recovery step.

The contents of the solid mix tank [109] are pumped into the zinc extraction reactor [200]. In the extraction step, the contents of the zinc extraction reactor [200] are adjusted with a solution of approximately 20% to 30%, and preferably about 25%, caustic in water such that, optimally, the weight of EAF dust comprises approximately 15% of the slurry weight. The percent solid in the slurry can vary from 10 to 20%. The total contents of the zinc extraction reactor shall optimally be one batch as defined by the size of the batch of EAF dust washed by water. The reactor preferably is constructed of monel. The contents of the zinc extraction reactor shall be mixed and heated to a preferred temperature of approximately 250 degrees Fahrenheit. The temperature may vary from 180 to 550 degrees Fahrenheit. The temperature shall be maintained for a period from one-half to twelve hours. A period of approximately three hours is preferred.

The reactor contents are pumped through a filter [201] to separate the extraction liquor, containing zinc, lead and other solubilized metals from the EAF dust, and the remaining solids which comprise the iron recycle stream.

In the cementation or displacement step, the extraction liquor is pumped to a cementation reactor [202]. The cementation reactor is a stirred heated vessel and the same size as the zinc extraction reactor. Powdered zinc is added to the cementation reactor to displace the lead and form metallic lead which will precipitate. Additional metals including but not limited to copper and cadmium will also be precipitated. The amount of zinc added is approximately from one to four times the stoichiometric amount required. After the powdered zinc is added the vessel contents are stirred and heated to approximately 180 degrees Fahrenheit for a period of approximately one-half hour. The temperature may vary from approximately 100 to 200 degrees Fahrenheit and the mixing period may vary from approximately 0.1 to 10 hours.

Next the metallic solids are removed by filtration [203]. The metallic solids may include excess powdered zinc added to the cementation reactor. The filter may be a filter press or rotary vacuum filter.

In the electrowinning step, the liquid from the filter [203] is pumped to a holding tank [204]. The holding tank may be from one to five times the volumetric size of the zinc extraction reactor. The solution may be diluted to approximately 10% but preferably is not. Contents of the hold tank are pumped through a polishing filter [205] into electrolytic cells [206]. Each cell typically may be 10 feet by 3.5 feet by 5 feet in dimension. A zinc anode and stainless steel cathode is used. A commercially available plating gelatin is added to a concentration of 0.5 grams per liter in order enhance the formation of grains. Plating conditions are 2 amperes and current density is 70 Amps per foot squared. Plating may be carried out from 0.1 to 10.0 hours but preferably 1.0 hours. Zinc [207] is removed from the plating electrode by removing the electrode from the cell and mechanically scraping it off.

The spent electrolytic solution from the electrolytic cells [206] is reused for additional extractions. It is pumped back to the zinc extraction reactor and solids mix tank and possibly a hold tank. A solution of approximately 50% caustic is added as necessary to adjust the % caustic in the extraction liquor to approximately 25% by weight.

In the gold recovery step, the solids from filter [201] can be further processed to extract metals of value that are identified. The extraction can but is not restricted to use of cyanide solutions or various proprietary solutions. The use of cyanide solutions is described herein. A 10% solution of sodium cyanide is mixed with the iron recycle stream in a solids mix tank [220]. The slurry is pumped to an extraction reactor [221], which is similar to the zinc extraction reactor and heated to approximately 200 degrees Fahrenheit for approximately three hours. The slurry is then pumped through a filter [222] to separate the cyanide solution.

The cyanide solution is then pumped to a reactor and is removed from the cyanide solution with a cementation reaction. Zinc powder is added to the cementation reactor [223] in an amount equal to approximately one to four times the stoichiometric amount required to precipitate gold. The slurry is heated to 200 degrees Fahrenheit for approximately three hours. The metallic gold [228] is then removed from the cyanide solution in a filter [224].

The remaining cyanide solution is pumped to a hold tank [225] then through a polishing filter [226] and into electrolytic cells [227]. Zinc is then plated as previously described with the exception that gelatin is not added to enhance the electrolysis. The spent cyanide solution is pumped back for reuse in the solids mix tank and possibly a holding tank. The concentration of cyanide is adjusted as necessary through addition of a 50% sodium cyanide solution stored in a holding tank.

The separated solids from filter [201], [203], filter [222] are then conveyed for further separation in order to recycle iron.

FIG. 1C shows the final step of the process, the thermal treatment of recycled iron stream. The iron recycle stream from filers [201], [203] and [222] is moved by a belt conveyor [300] into a rotary kiln [301]. Coke [302] is added to the stream on the belt conveyor. The water is removed in the heated screw conveyor [303]. The mixture is indirectly heated by fired natural gas in a rotary kiln [301] to approximately 1800 degrees Fahrenheit in the reducing atmosphere. The effect of the reducing atmosphere is to convert iron compounds to elemental iron and also release the remaining zinc tied up in those compounds as a fume or vapor [304]. The zinc is fumed off and the iron oxide becomes available to be reduced. The reduced iron stream is recycled back to the EAF [320].

The zinc fume is captured in a scrubber [305] by liquid spraying onto the fume stream. The scrubber is of typical design but rather than water spraying onto the stream, molten lead is sprayed because of the high temperatures involve. The zinc is condensed to a liquid and the zinc and lead are separated in a zinc/lead decanter [306]. The zinc/lead decanter is a typical liquid/liquid separator where the zinc phase and lead phase are separated by gravity. The lead and other metals recovered during previous cementation steps are added to this scrubbing loop after bring melted. The purpose of the addition is to allow separation of the lead from the zinc in the lead stream.

Both the zinc and excess lead are removed from the scrubbing circuit are cooled in a cooling conveyor [307].

In this embodiment, the products and by-products of the process are:
Lead—to be sent to a secondary lead smelter
Zinc—high purity for direct sale
Gold—for direct sale
Iron—to be recycled back to the electric arc furnace
Recycle extraction liquor—for reuse in the process
Halide salts for reuse as flux

Another feature of this invention is that it has been designed to minimize the generation of waste. There are additional metals in the EAF dust, the concentrations of which will build up in the recycle liquor and will ultimately be accumulated in the slimes of the electrolytic cell. The metals in the slimes have value. Once a sufficient volume of the slimes has built up, the slimes can be taken off site to a metals refinery. The slimes can be mixed with fine particles of copper and then fired to the melting point and allowed to cool. The solidified metal can be placed in an electrolytic cell where the copper will be removed by electrolysis, leaving the recovered metals. The copper can be reused for additional “copper firing.” In addition, halide salts can be removed from the initial water wash of the EAF dust. The extraction liquor can be recycled and reused in the metal extraction process.

Table 1 illustrates the performance of the present invention in benchscale tests on different types of EAF dust.

TABLE 1

| | | | | | | | Zinc | |
|---|---|---|---|---|---|---|---|---|
| | | | | CAKE | CAKE | CAKE | Extraction | |
| | EAFD | EAFD | EAFD | 25 | 25 | 25 | % | |
| Run | ZN | PB | Fe | Zn | Pb | Fe | (Based on | Extraction |
| Number | % | % | % | % | % | % | CAKE) | Conditions |
| 001 | 19.69 | 1.54 | 24.4 | 9.44 | 0.26 | 29.1 | 52.0 | (1) |
| 002 | 18.65 | 1.54 | 29.2 | 10.3 | 0.18 | 33.3 | 44.8 | (1) |
| 003 | | | | 11.4 | | | 38.9 | (1) |
| 004 | 16.87 | 1.71 | | 9.8 | 0.3 | | 41.9 | (1) |
| 005 | 16.81 | 1.56 | | 11.5 | 0.2 | | 31.6 | (1) |
| 006 | 20.26 | 1.61 | | 11.57 | 0.2 | | 42.9 | (1) |
| 007 | 19.91 | 1.69 | | 11.02 | 0.15 | | 44.7 | (1) |

Flux salts were analyzed and found to be calcium, sodium, potassium and magnesium chlorides. Weight of wetted Cake 25 equals weight of EAFD. The Density Liquor 10=1.13. Density Liquor 25=1.22. When EAFD for a particular run is not stated then 19.0% zinc is assumed. Extraction conditions: 10% caustic with caustic solution/EAFD ratio of 3 at 185 degrees Fahrenheit for ½ hour, then 25% caustic with caustic solution/EAFD ratio of 3 at 212 to 260 degrees Fahrenheit for 3 hours.

It is apparent that the above embodiments may be altered in many ways without departing from the scope of the invention. Further, various aspects of a particular embodiment may contain patentable subject matter without regard to other aspects of the same embodiment. Additionally, various aspects of different embodiments can be combined together. Also, those skilled in the art will understand that variations can be made in the number and arrangement of components illustrated in the above diagrams. It is intended that the appended claims include such changes and modifications.

What is claimed is:

1. A process for treating electric arc furnace dust comprising the steps of:
(a) water washing the dust with an aqueous solution;
(b) removing all solids from the aqueous solution;
(c) extracting the metals from the solid mixture resulting from step (b) by mixing the solid solution with a caustic solution of at least 15%;
(d) separating the solids from the extracting liquid from step (c);
(e) displacing the solid mixture from step (d) by mixing the solid mixture with finely divided zinc metal;
(f) heating the mixture from step (e);
(g) removing the solids from the mixture in step (f);
(h) electrowinning the liquid mixture from step (g);
whereby iron, lead, zinc and at least on precious metal are recovered.

2. The process according to claim 1, further comprising the steps of:
(i) mixing the solid mixture from step (g) with coke; and
(j) heating the mixture from step (i) in a rotary kiln to at least 1800 degrees Fahrenheit in a reducing atmosphere.

3. The process according to claim 1, further comprising the steps of:
(i) mixing the solid mixture from step (g) with a caustic solution;
(j) heating the mixture from step (i) to at least 200 degrees Farenheit;
(k) removing the solids from the mixture in step (j); and
(l) displacing the liquid mixture from step (k) by mixing the liquid mixture with zinc powder; and
(m) heating the mixture from step (l); and
(n) separating the solid metal from the mixture of step (m).
